(19) United States
(12) Patent Application Publication
(10) Pub. No.: US 2009/0051651 A1
(43) Pub. Date: Feb. 26, 2009

(54) APPARATUS FOR REMOTE POINTING USING IMAGE SENSOR AND METHOD OF THE SAME

(76) Inventors: Sang-Hyun Han, Seoul (KR); Jae-Han Lee, Suwon (KR); Chang-Suc Han, Incheon (KR); Woo-Seok Song, Anyang (KR)

Correspondence Address: SHERR & VAUGHN, PLLC, 620 HERNDON PARKWAY, SUITE 200, HERNDON, VA, 20170, US

(21) Appl. No.: 12/160,063

(22) PCT Filed: Jan. 5, 2006
(86) PCT No.: PCT/KR06/00038

§ 371 Date: Jul. 3, 2008

(51) Int. Cl. G06F 3/033

(52) U.S. Cl. 345/158

(57) ABSTRACT

Problem: since a remote pointing system using an image sensor and having a communication function through an infrared remote controller is used in various environments, the various environments have to be considered when designing the system. Solution: a signal reception unit outputs a control signal controlled to operate in a mode that corresponds to an infrared signal received from a remote controller among a remote control mode and a remote pointing mode. When receiving a control signal controlled to operate in the remote pointing mode from the signal reception unit, an image reception unit is operated to obtain a background image during a first signal reception section and obtains an optical image that corresponds to an infrared signal received from the remote controller during a second signal reception section. The infrared signal is not received during the first signal reception section and received during the second signal reception section from the remote controller. An image-processing unit creates a corrected optical image according to a difference value between the optical image and the background image. A pointing calculator calculates a distance up to the remote controller according to the size of the corrected optical image inputted from the image-processing unit and calculates a movement amount of the remote controller according to the calculated distance, thereby solving the above problem.

### TECHNICAL FIELD

The present invention relates to a remote pointing device and method using an image sensor, and more particularly, to a remote pointing device and method, capable of performing a pointing function according to a movement amount of an optical image received from a remote control device such as a remote controller used for remotely controlling home appliances.

### BACKGROUND ART

A pattern recognition technology extracting a predetermined image such as an image from an infrared LED light source generated from a remote control device is already widely used in image-processing of a commercial purpose.

Image-processing technology based on the pattern recognition technology is performed using two operations as follows.

A first operation is a pre-processing operation performed on a primitive image outputted from an image sensor such that an image-processing algorithm can be easily applied to the primitive image. The pre-processing operation removes additional information such as background and noise information of the image sensor (other than information appropriate for a process purpose) contained in the primitive image, and newly creates a virtual image processed in a predetermined form so that an image-processing algorithm to be used during a main-processing operation can be easily applied.

A second operation, which is the main-processing operation, is an operation of recognizing an image of a desired object in order to match the purpose of image-processing intended from the virtual image created during the pre-processing operation and extracting valid image information such as appearance state, displacement, color, and size of an object from the recognized image.

The pre-processing operation used for an image-processing technique with a purpose of pattern recognition should process or transform the primitive image with reference to information regarding expected appearance of an object, information created by a background, and information on the likelihood of operation results of an image-processing algorithm being used. Considering application fields of a remote pointing system using an image sensor and having a communication function through an infrared remote controller are digital televisions, set-top boxes, display devices, and game consoles, a remote pointing device is used in a variety of fields. Therefore, an image-processing technique used by the remote pointing device should process and transform the primitive image in order to match a desired purpose when disturbance due to light in an infrared band of natural light such as sunlight, disturbance due to light in an infrared band generated from an incandescent bulb and other artificial light sources, and disturbance due to light in an infrared band generated from a burning flame of combustion apparatus (e.g., candlelight, a heater, a gas stove, and a lighter) are generated during the pre-processing operation.

However, disturbing components generated during the pre-processing depending on a use environment are very ambiguous and information of a background screen that should be considered under a use environment is very complicated and exists in various forms due to interaction between various infrared components, so that it is very difficult to properly define the pre-processing function.

Even when a pre-processing operation having a high completeness is defined and performed, a case where a main-processing operation result is not desirable due to lots of separate infrared image components being present besides an infrared image from a remote controller is frequently generated. To correct image-processing results for such exceptional use environments, pre-examination for a variety of use environments should be performed. Also, since an additional operation should be performed on information regarding lots of use environments and a pre-processing operation should be performed, it is difficult to accomplish the purpose of the pre-processing for pattern recognition due to complexity of hardware and software for the pre-processing operation. Furthermore, since the pre-processing operation should be performed in real-time in view of the remote pointing device, it is very difficult to accomplish an object within a predetermined period of time using a prior art traditional image-processing technique.

When the main-processing operation is performed on the newly created image during the pre-processing operation, an attempt is made to perform pattern recognition using pre-processed images where a partial portion of a background image besides an infrared image and some of noises from an image sensor itself are mixed. Therefore, a binary image-processing technique (which is a very basic image-processing technique), which sets a critical value of an output value of a pixel outputted from an image, assigns 1 for an output value greater than the critical value, assigns 0 for an output value less than the critical value, creates a histogram for each pixel, and uses distribution of the created histogram, cannot guarantee reliability for results thereof. Also, to use an image-processing technique (which is a general image-processing technique used to trace a movement amount) through comparison of a previous screen with a current screen, a frame buffer storing three or more images such as a past image, a current image, and a difference between the two images is required. The three images are successively obtained from an infrared light source. Also, since a comparison mask should be set for each image and the comparison mask should be operated over an entire screen, an operation amount increases very much and results of the comparison are represented as unexpected various types of movement results in an aspect of movements of a light source. Furthermore, when a difference between a movement amount of a light source and a movement amount of a background screen is small or a movement amount of a predetermined portion of the background screen is greater than a movement amount of a light source, it is very difficult to perform a logical judgment for pattern recognition of an object. Also, since the area of a light source cannot be directly extracted, a complicate operation should be additionally performed to extract the area of the light source.

### DETAILED DESCRIPTION OF THE INVENTION

### Technical Problem

The present invention provides a remote pointing device and method using an image sensor, capable of simultaneously performing remote control and remote pointing according to information regarding a movement direction and distance of a remote controller calculated from a relative movement amount of an infrared light source obtained through image-processing of an image including an infrared light source from the remote controller.

The present invention also provides a computer-readable recording medium having a program recorded thereon, the program containing a remote pointing method using an image sensor, capable of simultaneously performing remote control and remote pointing according to information regarding a movement direction and distance of a remote controller calculated from a relative movement amount of an infrared light source obtained through image-processing of an image including an infrared light source from the remote controller.

### TECHNICAL SOLUTION

According to an aspect of the present invention, there is provided a remote pointing device using an image sensor, the device including; a signal reception unit outputting a control signal that allows the remote pointing device to operate in a mode that corresponds to an infrared signal received from a remote controller among a remote control mode allowing the remote pointing device to perform a control command that corresponds to an infrared signal received from the remote controller and a remote pointing mode allowing the remote pointing device to calculate a quantity of change of a pointing point according to an infrared signal received from the remote controller to perform a remote pointing operation; an image reception unit driven when a control signal that allows the remote pointing device to operate in the remote pointing mode is inputted from the signal reception unit, obtaining a background image during a first signal reception section, and obtaining an optical image that corresponds to an infrared signal received from the remote controller during a second signal reception section, the infrared signal not being received during the first signal reception section and being received during the second signal reception section from the remote controller; an image-processing unit creating a corrected optical image according to a difference between the optical image and the background image; and a pointing amount calculator calculating a distance up to the remote controller according to the size of the corrected optical image inputted from the image-processing unit and calculating a movement amount of the remote controller according to the calculated distance.

According to another aspect of the present invention, there is provided a remote pointing method using an image sensor, the method including: receiving an infrared signal from a remote controller; when a synchronization signal of a remote pointing mode is recognized from the received infrared signal, switching the image sensor from a stand by state to an operation state; obtaining a background image during a first signal reception section and obtaining an optical image that corresponds to an infrared signal received from the remote controller during a second signal reception section using the image sensor, the infrared signal not being received during the first signal reception section and being received during the second signal reception section from the remote controller; creating a corrected optical image according to a difference between the optical image and the background image; and calculating a distance up to the remote controller according to the size of the corrected optical image and calculating a movement amount of the remote controller according to the calculated distance.

Therefore, it is possible to realize a remote pointing system having high completeness, capable of stably obtaining and tracing information of a light source of a remote controller using a very small amount of hardware and software regardless of a use environment of the remote controller according to image information obtained by synchronizing an operation of the remote controller with that of a remote reception device.

### ADVANTAGEOUS EFFECTS

According to a remote pointing device and method using an image sensor of the present invention, it is possible to realize a remote pointing system having high completeness, capable of stably obtaining and tracing information of a light source of a remote controller using a very small amount of hardware and software in spite of use environment change compared to the prior art method by using image information obtained by synchronizing an operation of the remote controller with that of a remote reception device of the remote pointing system. Also, according to the present invention, it is possible to realize a new type of a remote pointing technique for information display, allowing a user to conveniently control and use an information display device of a digital television (TV), a set-top box, or a video-on-demand (VOD) in the same way as a user uses a personal computer by moving a mouse under a graphic user interface (GUI) environment, removing the need to press buttons using a display screen of a digital TV, a set-top box, or a VOD as is performed on an infrared remote controller.

### DESCRIPTION OF THE DRAWINGS

FIG. 1 is a block diagram of a construction of a remote pointing device using an image sensor according to an embodiment of the present invention.

FIG. 2 is a view of a remote controller.

FIG. 3 is a view illustrating an example of a remote pointing protocol of an infrared signal for remote pointing.

FIG. 4 is a view illustrating a detailed construction of a pointing start section of a remote pointing protocol.

FIG. 5 is a view illustrating a detailed construction of a pointing performance section of a remote pointing protocol.

FIG. 6 is a view of a background image obtained by an image reception unit.

FIG. 7 is a view illustrating an image where a background image obtained by an image reception unit and an infrared light source exist together.

FIG. 8 is a view illustrating a virtual image created by an image-processing unit according to an image illustrated in FIG. 6 and an image illustrated in FIG. 7.

FIG. 9 is a view illustrating an image created by an image-processing unit after the image-processing unit performs a masking process on a virtual image.

FIG. 10 is a view illustrating an image obtained by subtracting a screen where an infrared light source of a remote controller is turned off from a screen where the infrared light source of the remote controller is turned on, and a histogram thereof.

FIGS. 11 and 12 are views illustrating structures of 3×3 and 5×5 image masks used for removing a background component, respectively.

FIG. 13 is a view illustrating an image obtained by subtracting a screen where an infrared light source of a remote controller is turned off from a screen where the infrared light source of the remote controller is turned on and then removing a background component excluding an infrared image of the remote controller, and a histogram thereof.

FIG. 14 is a view illustrating a structure of a camera coordinate system using an image sensor for a reference.

FIG. 15 is a view illustrating an optical structure of an image reception unit of a remote pointing device using an image sensor according to an embodiment of the present invention and an image depending on a distance from a remote controller.

FIG. 16 is a flowchart of a remote pointing method using an image sensor according to an embodiment of the present invention.

### BEST MODE

The present invention will now be described more fully with reference to the accompanying drawings, in which exemplary embodiments of the invention are shown.

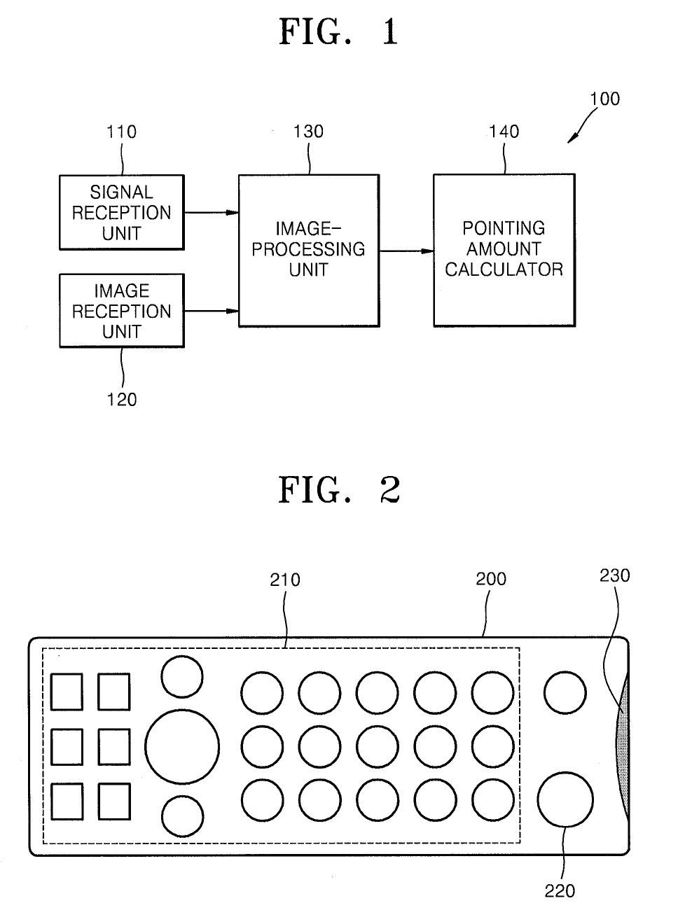

FIG. 1 is a block diagram of a construction of a remote pointing device 100 using an image sensor according to an embodiment of the present invention.

Referring to FIG. 1, the remote pointing device 100 includes a signal reception unit 110, an image reception unit 120, an image-processing unit 130, and a pointing amount calculator 140.

The signal reception unit 110 outputs a control signal that allows the remote pointing device 100 to operate in a mode that corresponds to an infrared signal received from a remote controller 200 (illustrated in FIG. 2) among a remote control mode performing a control command that corresponds to an infrared signal received from the remote controller 200, and a remote pointing mode calculating a change amount of a pointing point according to an infrared signal received from the remote controller 200 to perform a remote pointing operation.

The image reception unit 120 is driven to switch from a standby state to an operation state when a control signal that allows the remote pointing device 100 to operate in the remote pointing mode is inputted from the signal reception unit 110. The image reception unit 120 switched to the operation state obtains a background image during a first signal reception section, and obtains an optical image that corresponds to an infrared signal received from the remote controller 200 during a second signal reception section. The infrared signal is not received during the first signal reception section and is received during the second signal reception section from the remote controller 200.

The image-processing unit 130 creates a corrected optical image according to a difference between the obtained optical image and the background image.

FIG. 2 is a view of the remote controller 200.

Referring to FIG. 2, the remote controller 200 includes a manipulation button unit 210, a mode selection button 220, and a light-emitting unit 230. The manipulation button unit 210 includes buttons required for controlling home appliances, such as numerical keys, function selection buttons, and menu buttons. The mode selection button 220 controls an infrared reception device (e.g., the remote pointing device 100 using the image sensor according to the current embodiment of the present invention, or a home appliance including the same) and the remote controller 200 to switch between a remote control mode allowing the remote pointing device 100 and the remote controller 200 to perform a control command that corresponds to an infrared signal received from the remote controller 200, and a remote pointing mode calculating a change amount of a pointing point according to an infrared signal received from the remote controller 200 to allow the remote pointing device 100 and the remote controller 200 to perform a remote pointing operation. Since the operations of the remote controller 200 and an infrared reception device when the remote control mode is selected are well known in the art and do not contain the spirit of the present invention, detailed description thereof will be omitted.

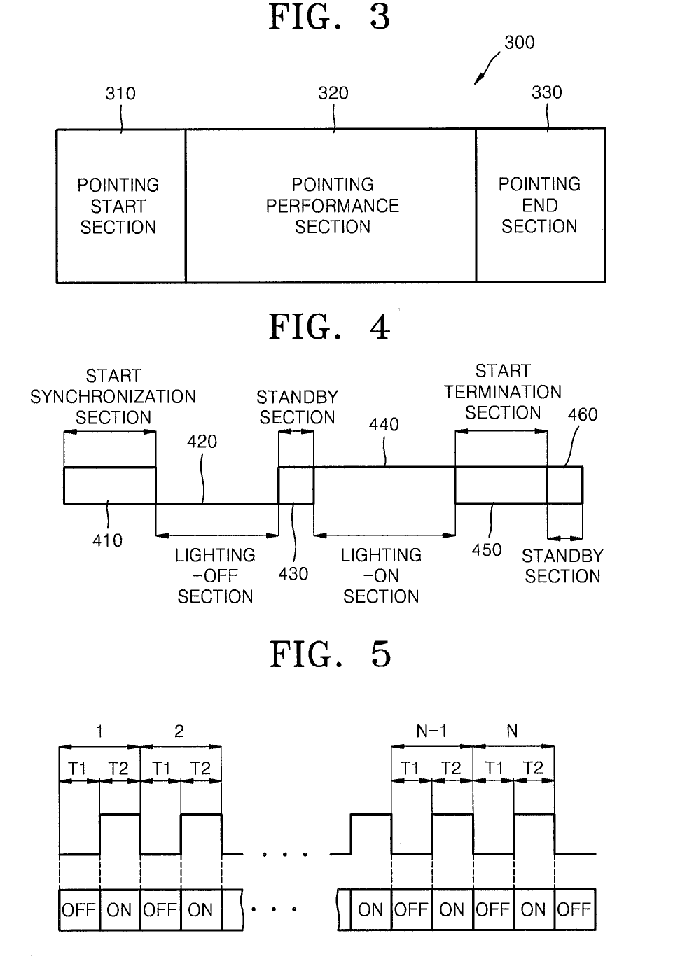

When the remote pointing mode is selected, the remote controller 200 and the infrared reception device operate differently from a general remote control mode, and a separate transmission protocol should be defined for the remote pointing mode. When a user manipulates the mode selection button of the remote controller 200 and performs the remote pointing mode in order to use the remote controller 200, which transmits an infrared signal to remotely control a home appliance, in a remote pointing state, the light-emitting unit 230 of the remote controller 200 transmits an infrared signal according to a remote pointing protocol 300 illustrated in FIG. 3.

Referring to FIG. 3, the remote pointing protocol 300 includes a pointing start section 310, a pointing performance section 320, and a pointing end section 330.

When a user manipulates a button of the remote controller 200 in order to perform remote pointing, the pointing start section 310 is activated. During the pointing start section 310, a lighting state of a light source of the remote controller 200 is manipulated according to a predetermined protocol, so that an infrared reception sensor provided to the signal reception unit 110 of the remote pointing device 100 using the image sensor according to the current embodiment of the present invention is allowed to recognize the start of a remote pointing operation. When a synchronization signal of the remote pointing mode contained the pointing start section 310 from an infrared signal is received from the remote controller 200, the signal reception unit 110 of the remote pointing device 100 using the image sensor controls the image reception unit 120 to switch a stand by state to an operation state.

FIG. 4 is a view illustrating a detailed construction of a pointing start section 310 of a remote pointing protocol.

Referring to FIG. 4, the pointing start section 310 includes a start synchronization section 410, a light-off section 420, a standby section 430, a light-on section 440, a start/end section 450, and a standby section 460. During the start synchronization section 410, the remote controller 200 transmits an infrared signal informing a start of infrared pointing, and the signal reception unit 110 recognizes a start synchronization signal from the received infrared signal to switch the image reception unit 120 from a standby state to an operation state. At this point, the image reception unit 120 performs an initialization process of the system required for obtaining an image.

During the light-off section 420, the remote controller 200 turns off an infrared light source for a predetermined period of time and stands-by. At this point, the signal reception unit 110 recognizes a light-off state of the infrared light source to control the image reception unit 120 to obtain a background image without the infrared light source, which is an object of image processing. Accordingly, the image reception unit 120 determines basic control values required for efficiently obtaining an image such as an auto exposure amount and a white balance value of the image sensor using the obtained background image, and obtains a new image using the determined values.

During the standby section 430, the remote controller 200 turns on or turns off the infrared light source according to a predetermined protocol and transmits information that at a current control state has ended and that a next control state has begun to the signal reception unit 110.

During the light-on section 440, the remote controller 200 stands by for a predetermined period of time with the infrared light source turned on. At this point, the signal reception unit 110 recognizes a lighting state of the infrared light source and controls the image reception unit 120 to obtain an image containing a background and the infrared light source of an object with the infrared light source, which is an object of image-processing, being present. The image reception unit 120 verifies validity of the basic control values of the image sensor set during the light-off section 420 using the obtained image. The image-processing unit 130 calculates the diameter of the infrared light source using a difference between the image obtained during the light-off section 420 and the image obtained during the light-on section 440, and derives a three-dimensional (3D) position of the infrared light source of the remote controller 200 within a camera coordinate system using the diameter of the infrared light source.

During the start termination section 450 and the standby section 460, the remote controller 200 transmits an infrared signal informing that the pointing start section 310 has ended and the pointing performance section 320 has started.

The pointing performance section 320 is a portion of a transmission signal protocol of an infrared light source transmitted by the remote controller 200 in an operation of directly moving, by a user, the remote controller 200 for remote pointing to display a pointing result on a display screen and performing remote control using the displayed pointing result. FIG. 5 is a view illustrating a detailed construction of a pointing performance section of a remote pointing protocol. Referring to FIG. 5, a signal of an infrared light source transmitted by the remote controller 200 during the pointing performance section 320 includes a signal standby section T1 where the infrared light source is turned off until a user accomplishes a predetermined object of remote pointing and ends the remote pointing, and a signal reception section T2 where the infrared light source is turned on. The remote controller 200 repeatedly transmits the infrared signal consisting of T1 and T2 until the remote pointing is ended. At this point, the temporal lengths of T1 and T2 are determined depending on the characteristics of the image sensor provided to the image reception unit 120 and an application of the pointing system, respectively. The temporal lengths of T1 and T2 should be set such that they are at least longer than a time used for the image sensor to obtain and output images consisting of one frame. Generally, T1 and T2 are set in a range of 1/10- 1/60 sec and used depending on the characteristics of the image sensor.

Therefore, a signal received through an infrared sensor provided to the signal reception unit 110 has a waveform having periods of T1 and T2. At this point, the image sensor provided to the image reception unit 120 obtains an image for a remote pointing operation in synchronization with a received signal as follows.

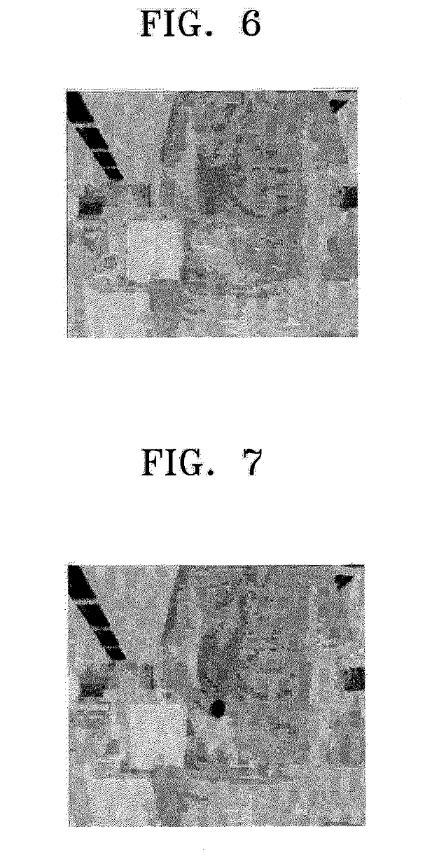

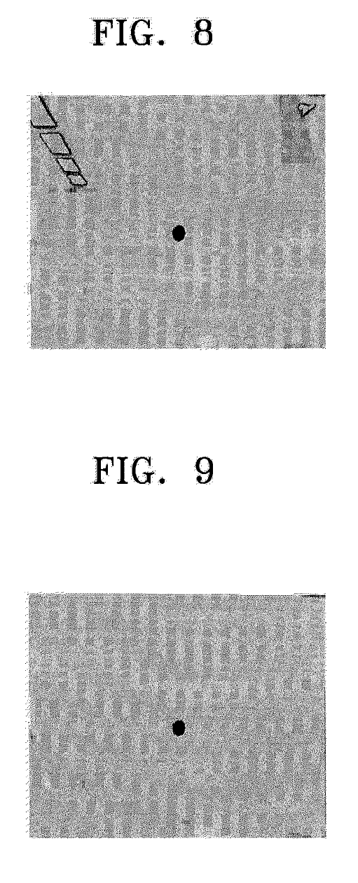

First, when the received signal is T1, the infrared light source is turned off, and the image reception unit 120 obtains a background image illustrated in FIG. 6. On the contrary, when the received signal is T2, the infrared light source is turned on, and the image reception unit 120 obtains an image containing a background and the infrared light source illustrated in FIG. 7. At this point, assuming that the image illustrated in FIG. 6 is P1 and the image illustrated in FIG. 7 is P2, the image-processing unit 130 obtains a difference between P1 and P2, and obtains an absolute value of the difference to create a virtual image illustrated in FIG. 8.

Assuming that the image illustrated in FIG. 8 is P3, an operation performed by the image-processing unit 130 is defined by Equation 1.

P3=|P2−P1| Equation 1

In the image illustrated in FIG. 8, an image of the infrared light source at the center remains as a main image and a background image is removed using Equation 1. However, there is possibility that an image of a change amount remains on a predetermined portion of the background besides the image of the infrared light source (that is to be extracted) because of movements of the background due to a difference in image obtain times or noises of the image sensor. When a histogram technique is applied to an image component illustrated in FIG. 8 to analyze accumulated image components of an X-axis and a Y-axis in order to check the image component of the background portion, results illustrated in FIG. 10 may be derived.

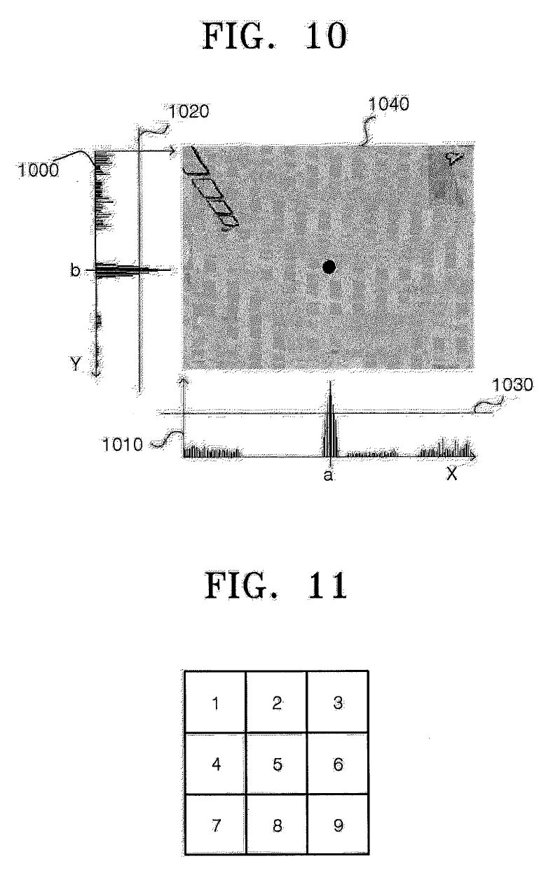

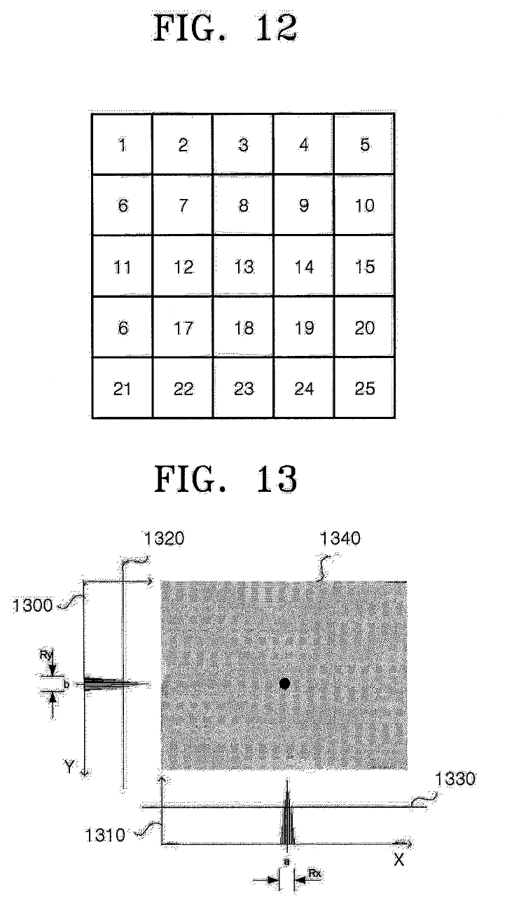

From analysis of the image illustrated in FIG. 10, it is intuitively known that a point b on a Y-axis and a point a on an X-axis are coordinates of the position of the infrared light source in view of a histogram 1000 for an image of a Y-axis component and a histogram 1010 for an image of an X-axis component. However, the image illustrated in FIG. 10 is a virtual image where there is a probability that threshold values 1010 and 1030 are difficult to set when a noise component on the background increases. Therefore, an image mask, which is a traditional image-processing technique, should be applied to the image illustrated in FIG. 8 to remove a noise component remaining on the background. Examples of the image mask are illustrated in FIGS. 11 and 12. At this point, an image mask of an appropriate size should be determined in order to remove the nose component. For example, a 3×3 image mask illustrated in FIG. 11 or a 5×5 image mask illustrated in FIG. 12 may be used depending on the noise component remaining on the background. Also, a variety of image masks including an image mask performing a low pass function, an image mask performing a smoothing function, and an image mask constituting a circular shape element should be selectively used in order to create a virtual image of a desired purpose.

FIG. 9 illustrates an image created by performing the above processes. Assuming that the image illustrated in FIG. 9 is P4 and an image mask used to form the image is a 3×3 mask having the smoothing function, P4 may be described by Equation 2.

$$P 4 = [ \begin{matrix}- 1 & - 1 & - 1 \\ - 1 & 9 & - 1 \\ - 1 & - 1 & - 1\end{matrix} ] \cdot P 3 \qquad Equation 2$$

A final image created using Equation 2 is an image processed such that only an image of an infrared light source (received from the remote controller 200) remains and background images and noise are removed. The image of the infrared light source should be recognized by the remote pointing device 100 using the image sensor according to the current embodiment of the present invention, and the movement trace of the infrared light source should be tracked by the remote pointing device 100, so that remote pointing information is derived.

When an image component illustrated in FIG. 9 is analyzed using a histogram technique, results illustrated in FIG. 13 may be derived.

From analysis of the image illustrated in FIG. 13, it is intuitively known that a point b on a Y-axis and a point a on an X-axis are coordinates of the position of the infrared light source in view of a histogram 1300 for an image of a Y-axis component and a histogram 1310 for an image of an X-axis component. Furthermore, since the image illustrated in FIG. 13 has almost no background noise component, it is easy to set threshold values 1320 and 1330, which are judgment reference values used for recognizing a pattern of a light source. Also, from the image illustrated in FIG. 13 it is possible to measure the shape, sizes Ry and Rx in a Y-axis direction and an X-axis direction of the light source of the remote controller 200 and the brightness of the light source by using the distribution of the histograms having a point b and a point a for their centers, respectively, and estimating accumulated values.

The pointing end section 330 is a portion of the transmission signal protocol of an infrared light source transmitted by the remote controller 200 in order to inform that the remote pointing mode has ended.

When receiving an infrared signal containing the pointing end section 330 transmitted from the remote controller 200 through a user's manipulation of the mode selection button 220 of the remote controller 200, an infrared reception device operating in the remote pointing mode or a home appliance including the remote pointing device using the image sensor according to the current embodiment of the present invention ends the remote pointing mode and switches to the remote control mode, which is the basic operation mode of the remote controller 200.

The pointing amount calculator 140 calculates a distance up to the remote controller 200 according to the size of a corrected optical image inputted from the image-processing unit 130, and calculates a movement amount of the remote controller 200 according to the calculated distance.

When the remote pointing is performed using an infrared light-emitting diode (LED) light source, the LED light source provided to the remote controller 200 contains not only up/down and right/left position information based on a user's intended movement but also information regarding a distance between the remote controller 200 and the signal reception unit 110 of the remote pointing device 100 using the image sensor according to the current embodiment of the present invention. Therefore, a space in which the infrared LED light source of the remote controller 200 is located may be analyzed using position information of a 3D space having the image reception unit 120 for a reference.

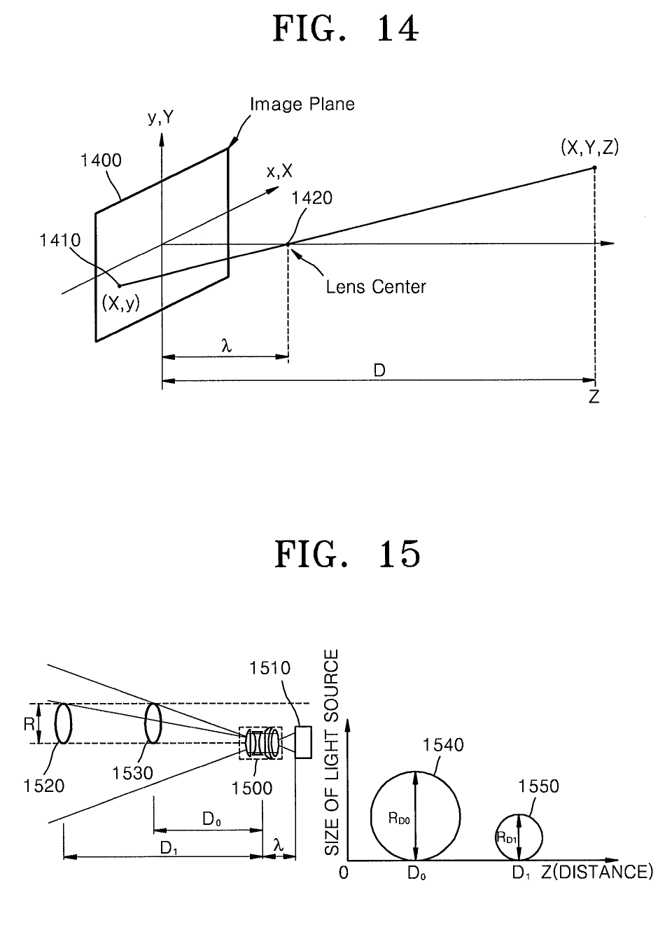

Such a 2D space may be defined as a camera coordinate system illustrated in FIG. 14 in a field of image processing.

FIG. 15 is a view illustrating an optical structure of an image reception unit of a remote pointing device using an image sensor according to an embodiment of the present invention and an image depending on a distance from a remote controller.

Referring to FIG. 15, the image reception unit 120 (of FIG. 1) includes a lens set 1500 and an image sensor 1510. The remote controller 200 (of FIG. 2) may be described using an infrared light source 1520 of the remote controller 200 located at a distance D1 from the lens set 1500 and another infrared light source 1530 of the remote controller 200 located at a distance D0 from the lens set 1500. At this point, a distance between the lens set 1500 and the image sensor 1510 is generally very small compared to a distance D1 or D0 between the lens set 1500 and the infrared light source 1520 or 1530 of the remote controller 200. Therefore, a distance D1 or D0 between the lens set 1500 and the light source 1520 or 1530 of the remote controller 200 may be approximated as a distance between the image sensor 1510 and the light source 1520 or 1530 of the remote controller 200 when calculation is performed.

The remote pointing device 100 using the image sensor according to the current embodiment of the present invention uses image information created by projecting position information of the remote controller 200 in a 3D space onto the 2D image sensor 1530 provided to the image reception unit 120 through the optical lens set 1500 illustrated in FIG. 15. That is, during a process of extracting 2D pointing information projected on to the image sensor 1530, a distance between the image sensor 1510 and the light source 1520 or 1530 is determined, and then an actual movement amount in vertical/horizontal directions is measured using the determined distance for a reference. A relative movement amount is compensated according to the measured movement amount of the remote controller 200 such that a vertical or horizontal remote pointing result on a displayed screen is constant regardless of a distance between the remote controller 200 and the image sensor 1510.

Referring to FIG. 15, the infrared light source 1520 having a diameter R and located at the distance D1 from the lens set 1500 is located at a relatively far point compared to the infrared light source 1530 located at the distance D0 from the lens set 1500, so that a size 1550 of the light source 1520 obtained by the image sensor 1510 is relatively small in view of a geometrical-optical configuration passing through the lens set 1500. Also, since the infrared light source 1530 having a diameter R and located at the distance D0 from the lens set 1500 is located at a relative near point compared to the infrared light source 1520 located at the distance D1 from the lens set 1500, a size 1540 of the light source 1530 obtained by the image sensor 1510 is relatively large in view of a geometrical-optical configuration passing through the lens set 1500.

At this point, though the actual diameters R of the two infrared light sources 1530 and 1520 located at different distances D0 and D1, respectively, are the same, the images 1540 and 1550 of the two light sources 1530 and 1520 obtained by the image sensor are represented in different sizes.

Assuming that an actual diameter of the infrared light source 1530 located at the distance D0 is RD0 and an actual diameter of the infrared light source 1520 located at the distance D1 is RD1, the relationship between the diameters R and R1 of the images 1540 and 1550 received from the different distances D0 and D1 may be described using Equation 3.

D_{0S}R_{D0}=D_{1S}R_{D1} Equation 3

Therefore, the infrared light source contained in an image obtained through the image sensor 1510 at a place far away from the image sensor 1510 is represented as a small size compared to the infrared light source contained in an image obtained through the image sensor 1510 at a place close to the image sensor through the image sensor 1510. On the contrary, the infrared light source contained in an image obtained through the image sensor 1510 at a place close to the image sensor through the image sensor 1510 is represented as a large size compared to the infrared light source contained in an image obtained through the image sensor 1510 at a place far away from the image sensor 1510. The brightness (luminance) of the infrared light source is also reduced as a distance between the image sensor 1510 and the infrared light source is large. Also, examination of the light source's image actually obtained through the image sensor 1510 shows that a movement of the infrared light source of the remote controller 200 actually having the same physical movement amount is outputted in a large pointing variation value with a relatively bright infrared light amount for a close distance and outputted in a small pointing variation value with a relatively dark infrared light amount. Therefore, a pointing value from the image of the light source simply obtained from the image sensor 1510 cannot be directly used as a pointing value of the remote controller 200 and an actual pointing amount should be calculated and used in consideration of a relationship associated with the distance between the infrared light source 1520 or 1530 and the lens set 1500.

The remote pointing device and method using the image sensor according to the current embodiment of the present invention calculates the distance between the remote controller and the image sensor using a method below in order to determine an actual effective pointing movement amount of a light source from the light source's image obtained by the image sensor.

When the diameter R of the light source 1520 illustrated in FIG. 15 is known in advance, assuming that a distance between the lens set 1500 and the infrared light source 1520 is D1, a distance between the lens set 1500 and the image sensor 1510 is λ, and a diameter of an image of the light source 1520 obtained by the image sensor 1510 is RD1, a relationship between these parameters is given by an equation below.

D₁:R=λ:R_{D1} Equation 4

From Equation 4, the distance D1 between the light source 1520 and the lens set 1500 is obtained using Equation 5.

$${D}_{1} = \frac{( RS λ )}{{R}_{D 1}} \qquad Equation 5$$

where, R and λ are constants defined from a hardware structure of the remote pointing device using the image sensor 1510 according to the current embodiment of the present invention, and RD1 is a value obtained from the image sensor 1510. It is possible to calculate a distance D1 between the remote controller 200 and the image sensor 1510 using Equation 5. Since the above calculated distance may have an optical error of the lens set 1500 and an error more or less due to λ, which is a very small value compared to RD1 when actually applied, it is possible to derive a more accurate distance by making a table containing actual measurements of actual distances and sizes of received light sources and correcting the calculated distance.

When the distance derived using Equation 5 is applied to the camera coordinate system illustrated in FIG. 14, a light source's image existing in a 3D space expressed in terms of a position (X, Y, Z) on an actual camera coordinate system with known values λ and D, passes through a central point 1420 of the lens set and exists as a 2D project image on a position (x, y) of a plane 1400 of the image sensor 1510. At this point, a Z coordinate (on the image sensor) of a light source having a 3D coordinate (X, Y, Z) may be obtained by adding λ to the result calculated using Equation 5. That is, the Z coordinate of the light source is obtained using an equation below.

Z=D₁+λ Equation 6

Also, an X coordinate (on the image sensor) of a light source having a 3D coordinate (X, Y, Z) projected on the image sensor may be obtained using an equation below.

$$\frac{x}{λ} = - \frac{X}{Z - λ} \qquad Equation 7$$

Equation 7 may be expressed in terms of a relational expression for an X coordinate of a light source to be obtained as follows:

$$X = \frac{( λ - Z ) Sx}{λ} \qquad Equation 8$$

Likewise, a Y coordinate (on the image sensor) of a light source having a 3D coordinate (X, Y, Z) projected on the image sensor may be obtained using an equation below.

$$\frac{y}{λ} = - \frac{Y}{Z - λ} \qquad Equation 9$$

The equation 7 may be expressed in terms of a relational expression for an X coordinate of a light source to be obtained as follows:

$$Y = \frac{( λ - Z ) Sy}{λ} \qquad Equation 10$$

Therefore, when the quantity of change of a light source's 3D coordinate (X, Y, Z) derived using Equations 6, 8, and 10 is calculated in terms of a remote pointing amount, it is possible to perform remote pointing by sufficiently reflecting a movement amount of an infrared LED light source of the actual remote controller 200. Accordingly, it is possible to calculate in real-time a 3D spacial coordinate of a light source of the remote controller 200 in the camera coordinate system illustrated in FIG. 14 using the periods T1 and T2 illustrated in FIG. 5 on the basis of a coordinate (a,b) (projected on the image sensor) of an image of a light source of the remote controller, a diameter Rx or Ry of the light source, and the already known distance λ between the lens set and the image sensor. Also, a quantity of change of a position of the remote controller using the image sensor is traced from a quantity of change on a 3D coordinate of the light source of each period, and the traced quantity of change is derived as a pointing result.

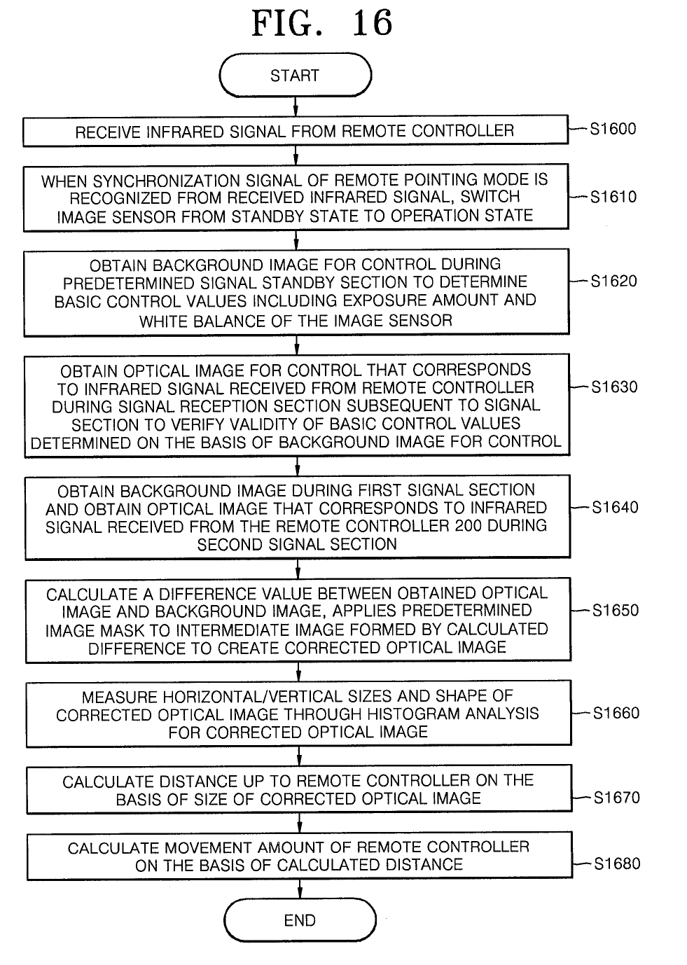

FIG. 16 is a flowchart of a remote pointing method using an image sensor according to an embodiment of the present invention.

Referring to FIG. 16, the signal reception unit 110 receives an infrared signal from the remote controller 200 (S1600). When a synchronization signal is recognized from the received infrared signal, the signal reception unit 110 switches the image reception unit 120 from a standby state to an operation state (S1610). The image reception unit 120 obtains a background image for control during a predetermined signal standby section to determine basic control values including an exposure amount and a white balance of the image sensor provided to the image reception unit 120 (S1620). Also, the image reception unit 120 obtains an optical image for control that corresponds to an infrared signal received from the remote controller 200 using the image sensor during a signal reception section subsequent to the signal standby section to verity validity of the basic control values determined according to the background image for control (S1630).

Next, the image reception unit 120 obtains a background image during a first signal section and obtains an optical image that corresponds to an infrared signal received from the remote controller 200 during a second signal section (S1640). The infrared signal is not inputted during the first signal section and inputted during the second signal section from the remote controller 200. The optical image obtained by the image reception unit 120 during the second signal section includes both an infrared light source emitted from the remote controller 200 and a background image.

The image-processing unit 130 calculates a difference between the optical image and the background image obtained by the image reception unit 120, applies a predetermined mask to an intermediate image formed by the calculated difference to create a corrected optical image (S1650). Next, the image-processing unit 130 measures the horizontal/vertical sizes and the shape of the corrected optical image through histogram analysis for the corrected optical image (S1660).

The pointing amount calculator 140 calculates a distance up to the remote controller 200 according to the size of the corrected optical image (S1670). At this point, the pointing amount calculator 140 calculates the distance up to the remote controller 200 using Equation 5 or stored distance data.

Next, the pointing amount calculator 140 calculates a movement amount of the remote controller 200 according to the calculated distance (S1680). At this point, the pointing amount calculator 140 calculates a coordinate (X, Y, Z) of the remote controller 200 on a spacial coordinate system having the center of the image sensor constituting the image reception unit 130 for its origin using Equations 6, 8, and 10.

The purpose of the turning-on and turning-off of the infrared light source of the remote controller by the periods T1 and T2 with respect to the infrared signal during the pointing performance process illustrated in FIG. 5 in the above-described image-processing technique, is to make the infrared light source's image (which is an object of pattern recognition) more conspicuous than the background or noise image (which is an object of removal in pattern recognition) by sequentially obtaining two kinds of images where existence of the infrared light is clearly contrasted as illustrated in FIGS. 6 and 7, and processing an image using a difference between the two images.

Also, since the turning-on of the infrared light source of the remote controller is synchronized with the turning-off of the infrared light source to obtain an image, a pre-processing operation having a very high completeness may be performed a very small number of times and at very fast speed compared to the prior art image-processing technique. Also, since the main processing operation is performed using clearly contrasted images of the light source, not only accuracy of the judgment for pattern recognition is maximized but also the size and the brightness of the infrared light source may be easily derived using a simple calculation.

According to the prior art device (a general remote controller) that turns on an infrared light source using a carrier frequency band ranging from 37 KHz to 38 KHz, a time of a frame during which an image sensor of a remote receiver receives an image cannot be synchronized with turning-on of the light source, so that a non-uniform light source's image is obtained, which makes image processing very difficult. The present invention may solve such a problem. When an image obtained from the remote controller with the infrared light source always turned-on is processed, considerations of background noise increase and thus an image processing amount increases very much. The present invention may solve such a problem. The remote controlling according to the present invention has an additional advantage of increasing the life of a battery, which is a power source of the remote controller, about 50% compared to remote controlling where remote pointing is performed while power is supplied to the remote controller.

The invention can also be embodied as computer-readable codes on a computer-readable recording medium. The computer-readable recording medium is any data storage device that can store data which can be thereafter read by a computer system. Examples of the computer-readable recording medium include read-only memory (ROM), random-access memory (RAM), CD-ROMS, magnetic tapes, floppy disks, optical data storage devices, and carrier waves (such as data transmission through the Internet). The computer-readable recording medium can also be distributed over network-coupled computer systems so that the computer-readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims.

1-16. (canceled)

17. An apparatus comprising a remote pointing device, wherein the remote point device comprises:
an image sensor;
a signal reception unit configured to output a control signal designating at least one of a remote control mode and a remote point mode, wherein:
the output control signal is based on a received infrared signal,
the received infrared signal is from a remote controller,
the remote control mode is configured to allow the remote pointing device to perform a control command included in the infrared signal, and
the remote pointing mode is configured to allow the remote pointing device to calculate a change in movement of a pointing point according to the infrared signal to perform a remote pointing operation;
an image reception unit driven by the control signal from the signal reception unit configured to allow the remote pointing device to operate in the remote pointing mode, wherein the remote point mode is configured to:
obtain a background image during a first signal reception period, and
obtain an optical image according to the infrared signal during a second signal reception period, wherein the infrared signal is not received during the first signal reception period and the infrared signal is received during the second signal reception period;
an image-processing unit configured to create a corrected optical image according to a difference between the optical image and the background image; and
a pointing amount calculator configured to calculate a distance to the remote controller according to the size of the corrected optical image from the image-processing unit and calculate an amount of movement of the remote controller based on the calculated distance.

18. The apparatus of claim 17, wherein the signal reception unit comprises:
a receiver configured to receive the infrared signal from the remote controller; and
a controller, wherein:
the controller is configured to output a first control signal,
the first control signal controls the image reception unit to switch from a standby state to an operation state when a synchronization signal of the remote pointing mode is included in the received infrared signal, and
the controller is configured to output a second control signal that controls the image reception unit to operate until an end signal of the remote pointing mode is included in the received infrared signal.

19. The apparatus of claim 18, wherein:
when the first control signal is received, the image reception unit obtains a background image during a predetermined signal standby period;
the background image is used to determine basic control values, wherein the basic control values comprises exposure amount and a white balance value of the image sensor;
when the first control signal is received, the image reception unit obtains an optical image that corresponds to the infrared signal during a signal reception period, wherein the signal reception period is after the signal standby period;
the optical image is used to verify validity of the basic control values.

20. The apparatus of claim 17, wherein the first signal reception period and the second signal reception period are longer than a period of time of one frame used by the image reception unit to obtain and output image information.

21. The apparatus of claim 17, wherein the image-processing unit comprises:
a difference value calculator configured to calculate a difference between the optical image and the background image;
a corrector configured to apply a predetermined image mask to an intermediate image created using the calculated difference to create the corrected optical image; and
an optical image analyzer configured to analyze a histogram of the corrected optical image to measure a horizontal size, a vertical size, and a shape of the corrected optical image.

22. The apparatus of claim 17, wherein the pointing amount calculator calculates a distance to the remote controller using an equation
$${D}_{1} = \frac{( RS λ )}{{R}_{D 1}} ,$$
wherein D₁ is the distance to the remote controller, R is the diameter of a light source, λ is a distance between the image sensor and a lens in front of the image sensor, and R_{D1} is the diameter of the optical image.

23. The apparatus of claim 22, wherein the pointing amount calculator calculates coordinates X, Y, and Z of the remote controller on a space coordinate system with the center of the image sensor as the origin of the space coordinate system, using equations
$$X = \frac{( λ - Z ) Sx}{λ} , Y = \frac{( λ - Z ) Sy}{λ} ,$$
wherein Z is the distance to the remote controller, λ is a distance between the image sensor and a lens in front of the image sensor, and x and y are coordinates in an x-axis and a y-axis, respectively, on a plane of the image sensor having an origin at the center of the image sensor.

24. The apparatus of claim 17, wherein the pointing amount calculator calculates the distance to the remote controller according to distance calculation data that comprises an actual measurement of the distance to the remote controller that corresponds to the size of the optical image.

25. The apparatus of claim 24, wherein the pointing amount calculator calculates coordinates X, Y, and Z of the remote controller on a space coordinate system with the center of the image sensor as the origin of the space coordinate system, using equations
$$X = \frac{( λ - Z ) Sx}{λ} , Y = \frac{( λ - Z ) Sy}{λ} ,$$
wherein Z is the distance to the remote controller, λ is a distance between the image sensor and a lens in front of the image sensor, and x and y are coordinates in an x-axis and a y-axis, respectively, on a plane of the image sensor having an origin at the center of the image sensor.

26. A method comprising:
receiving an infrared signal from a remote controller;
when a synchronization signal of a remote pointing mode is recognized from the received infrared signal, switching the image sensor from a standby state to an operation state;
obtaining a background image during a first signal reception period;
obtaining an optical image from the infrared signal during a second signal reception period using the image sensor, wherein the infrared signal is not received during the first signal reception period and the infrared signal is received during the second signal reception period;
creating a corrected optical image according to a difference between the optical image and the background image; and
calculating a distance to the remote controller according to the size of the corrected optical image and calculating an amount of movement of the remote controller according to the calculated distance.

27. The method of claim 26, wherein the switching comprises:
when the synchronization signal is recognized, obtaining a background image during a predetermined signal standby period using the image sensor to determine basic control values, wherein the basic control values comprise an exposure amount and a white balance value of the image sensor; and
obtaining an optical image from the infrared signal using the image sensor during a signal reception period, wherein the signal reception period is after the signal standby period, and wherein the optical image is used to verify validity of the basic control values.

28. The method of claim 26, wherein the first signal reception period and the second signal reception period are longer than the time of one frame of the image reception unit that obtains and outputs image information.

29. The method of claim 26, wherein said creating the corrected optical image comprises:
calculating a difference between the optical image and the background image;
applying a predetermined image mask to an intermediate image created using the calculated difference to create the corrected optical image; and
analyzing a histogram of the corrected optical image to measure a horizontal size, a vertical size, and a shape of the corrected optical image.

30. The method of claim 26, wherein said calculating the distance to the remote controller comprises using an equation
$${D}_{1} = \frac{( RS λ )}{{R}_{D 1}} ,$$
wherein D₁ is the distance to the remote controller, R is the diameter of a light source, λ is a distance between the image sensor and a lens in front of the image sensor, and R_{D1} is the diameter of the optical image.

31. The method of claim 30, wherein the calculating of the distance to the remote controller comprises calculating coordinates X, Y, and Z of the remote controller on a space coordinate system with the center of the image sensor as the origin of the space coordinate system, using equations
$$X = \frac{( λ - Z ) Sx}{λ} , Y = \frac{( λ - Z ) Sy}{λ} ,$$
wherein Z is the distance to the remote controller, λ is a distance between the image sensor and a lens in front of the image sensor, and x and y are coordinates in an x-axis and a y-axis, respectively, on a plane of the image sensor having an origin at the center of the image sensor.

32. The method of claim 26, wherein said calculating the distance to the remote controller comprises calculating the distance up to the remote controller according to distance calculation data comprising an actual measurement of the distance to the remote controller that corresponds to the size of the received optical image.

33. The method of claim 32, wherein the calculating of the distance to the remote controller comprises calculating coordinates X, Y, and Z of the remote controller on a space coordinate system with the center of the image sensor as the origin of the space coordinate system, using equations
$$X = \frac{( λ - Z ) Sx}{λ} , Y = \frac{( λ - Z ) Sy}{λ} ,$$
wherein Z is the distance to the remote controller, λ is a distance between the image sensor and a lens in front of the image sensor, and x and y are coordinates in an x-axis and a y-axis, respectively, on a plane of the image sensor having an origin at the center of the image sensor.

34. A computer-readable recording medium having a program recorded thereon, wherein the program contains the method of claim 26.
